(19) United States
(12) Patent Application Publication
(10) Pub. No.: US 2013/0155447 A1
(43) Pub. Date: Jun. 20, 2013

(54) ELECTRONIC DEVICE SYSTEM, ELECTRONIC DEVICE, AND STORAGE MEDIUM

(71) Applicant: Sharp Kabushiki Kaisha, Osaka-shi (JP)

(72) Inventor: Daisuke FUJIKI, Osaka-shi (JP)

(73) Assignee: SHARP KABUSHIKI KAISHA, Osaka-shi (JP)

(21) Appl. No.: 13/715,220

(22) Filed: Dec. 14, 2012

(30) Foreign Application Priority Data
Dec. 19, 2011 (JP) 2011-277542

(51) Int. Cl. G06K 15/02

(52) U.S. Cl. CPC G06K 15/02
USPC 358/1.14

(57) ABSTRACT

An electronic device system, an electronic device and a storage medium are provided that prevent processing by a control program stored in a non-certified storage medium.

An SDIO device 102 stores a control program 51a, and outputs the control program 51a from an SD pin unit 40. To an extended pin unit 41, a connection check signal from an electronic device 101 is inputted. A response signal from a response circuit unit 53 is outputted from the extended pin unit 41 to the electronic device 101. An input-output IF 14 obtains the response signal from the extended pin unit 41. A control unit 1 determines whether the SDIO device 102 is connected based on the obtained response signal, and when it is connected, executes the control program 51a by a processing unit 10.

### CROSS-REFERENCE TO RELATED APPLICATIONS

This Nonprovisional application claims priority under 35 U.S.C. §119(a) to Patent Application No. 2011-277542 filed in Japan on Dec. 19, 2011, the entire contents of which are hereby incorporated by reference.

### BACKGROUND

1. Technical Field

The present invention relates to: an electronic device system provided with a storage medium and an electronic device to which the storage medium is detachably and attachably connected and that executes processing by a program read from the storage medium; the electronic device; and the storage medium.

2. Description of Related Art

Many electronic devices such as notebook PCs (personal computers) and tablet portable terminals are provided with a connection interface to which an external device is connected to perform data transfer. The electronic devices, for example, read data of music, video and the like stored in the device connected to the connection interface and use it, and further, it is performed to activate the electronic device by a program installed on the connected device. An example of the connection interface that the electronic devices are provided with is an SD (secure digital) interface, and an example of the connected device is an SD memory card having the SD interface.

Japanese Patent Application Laid-Open No. 2007-086920 discloses a portable electronic device having a CPU (central processor unit), a RAM (random access memory), a memory controller, a reset controller, an SD memory card and a key matrix. This portable electronic device reads a boot program from the SD memory card and executes it when receiving power supply from an external power source under a condition where a specific key in the key matrix is depressed. Specifically, the memory controller relocates the RAM at address 0 of the memory address, and reads the boot program stored in the SD memory card into the RAM. The reset controller holds the CPU in reset state during the reading of the boot program from the SD memory card, and after the reading, the reset controller releases the CPU from the reset state. The CPU having been released from the reset state starts a fetch from address 0 of the memory address, whereby the processing by the boot program read into the RAM is executed. Thereby, even in a case such as when no boot program is present in the portable electronic device or when although the boot program is present, it does not run normally because of an initial failure, the portable electronic device can be activated by the boot program stored in the SD memory card.

### SUMMARY OF THE INVENTION

On the other hand, as for electronic devices for home and industrial uses, a multiplicity of models have been commercialized to meet diversified user needs. For example, for image forming apparatuses, a wide variety of models ranging from low-end models to high-end models with the difference in performance such as printing speed are developed and provided to users. For such electronic devices including a multiplicity of models, to provide products more inexpensively, measures are taken such as commonalizing the circuit board among models to suppress manufacturing cost (for example, see Japanese Patent Application Laid-Open No. H09-134279).

However, according to the technology described in Japanese Patent Application Laid-Open No. 2007-086920, with an electronic device activated by a control program read from a storage medium such as an SD memory card storing the program, there is a problem in that the control program is illegally copied to another storage medium card and used for another electronic device. For example, when the control program is illegally copied from a certified SD memory card provided by the manufacturer of the electronic device to a non-certified SD memory card of a different quality and the non-certified SD memory card is connected to the electronic device, a problem occurs in that a control program read error is caused or that the program read speed is reduced to retard the operation of the electronic device.

It can also be considered that the control program for a high-end model is copied to a storage medium and the storage medium is connected to a low-end model for illegal use. For example, when the circuit board is commonalized as in the image forming apparatuses mentioned above, a problem occurs in that a control program that enables high speed printing for a high-end model is illegally used for a low-end model with low printing speed. In the image forming apparatuses, since hardware optimization is performed such as using different developer toner agents according to the printing performance between low-end models and high-end models, if high speed printing for a high-end model is performed in a low-end model, it rather results in performance degradation such that the developer toner agent scatters to degrade image quality, and this can be a cause of a failure.

The present invention is made in view of such circumstances, and an object thereof is to provide an electronic device system, an electronic device and a storage medium that prevent processing by a control program stored in a non-certified storage medium.

In an electronic device system according to the present invention provided with: a storage medium storing a program and outputting the program from a first pin; and an electronic device to which the storage medium is detachably connected so as to read the program from the storage medium and execute processing by the program, the storage medium is provided with: a response unit that outputs a response signal in response to a connection check signal outputted from the electronic device; and a second pin to which the connection check signal is inputted and outputting the response signal outputted by the response unit, and the electronic device is provided with: an input-output unit that outputs the connection check signal to the second pin and obtains the response signal from the second pin; a determination unit that determines whether the storage medium is connected or not based on the response signal obtained by the input-output unit; and a processing unit that executes processing by the program when the determination unit determines that the storage medium is connected. This enables the electronic device to determine whether a certified storage medium having the second pin is connected or not based on the response signal, from the storage medium, in response to the connection check signal and execute the processing by the program.

In the electronic device system according to the present invention, the electronic device is provided with an identification information storage unit storing identification information of the electronic device itself, the input-output unit outputs the identification information stored in the identification information storage unit, the response unit outputs the response signal based on the inputted identification information, and when the identification information stored in the identification information storage unit coincides with identification information obtained based on the response signal, the determination unit determines that the storage medium is connected. This enables the electronic device to execute the processing by the program read from the storage medium that correctly returns the response signal based on the identification information.

In the electronic device system according to the present invention, the identification information is added to the program stored in the storage medium, the electronic device is provided with a second determination unit that determines whether or not the identification information obtained based on the response signal coincides with the identification information obtained from the program, and when the determination unit determines that the storage unit is connected and the second determination unit determines that the identification information coincides, the processing unit executes processing by the program. This enables the electronic device to execute the processing by the program to which the identification information coinciding with the identification information obtained by the response signal is added.

In the electronic device system according to the present invention, the storage medium is an SDIO (secure digital input output) compliant memory card in which a plurality of pins including the first pin have an SD (secure digital) interface and the second pin is provided. This enables the storage medium to be structured in compliance with the SDIO standard.

In an electronic device according to the present invention that reads a program from an external storage medium and executes processing by the program, the following are provided: a program pin to which the program is inputted; a connection check pin that outputs, to an external device, a connection check signal to check connection and to which a response signal in response to the connection check signal is inputted; an input-output unit connected to the connection check pin and outputting the connection check signal and obtaining the response signal; a determination unit that determines whether the storage medium is connected or not based on the response signal; and a processing unit that executes, when the determination unit determines that the storage medium is connected, processing by the program inputted to the program pin. This enables the electronic device to determine whether a certified storage medium having a pin corresponding to the connection check pin is connected or not based on the response signal, from the storage medium, in response to the connection check signal and execute the processing by the program.

In the electronic device according to the present invention, the electronic device is provided with an identification information storage unit storing identification information of the electronic device itself, the input-output unit outputs the identification information stored in the identification information storage unit, and when the identification information stored in the identification information storage unit coincides with identification information obtained based on the response signal, the determination unit determines that the storage medium is connected. This enables the electronic device to execute the processing by the program read from the storage medium that correctly returns the response signal based on the identification information.

In the electronic device according to the present invention, the identification information is added to the program, the electronic device is provided with a second determination unit that determines whether or not the identification information obtained based on the response signal coincides with the identification information obtained from the program, and when the determination unit determines that the storage unit is connected and the second determination unit determines that the identification information coincides, the processing unit executes processing by the program. This enables the electronic device to execute the processing by the program to which the identification information coinciding with the identification information obtained by the response signal is added.

A storage medium according to the present invention connected to an external electronic device and storing a program and outputting the program from a first pin is provided with: a response unit that outputs a response signal in response to an externally inputted connection check signal; and a second pin to which the connection check signal is inputted and outputting the response signal outputted by the response unit. This enables a structure in which the response signal in response to the connection check signal is outputted to an external electronic device from a pin different from the pin that outputs the program and the electronic device determines whether the storage device is a certified one or not.

In the storage device according to the present invention, the response unit outputs the response signal, based on identification information of the electronic device included in the connection check signal. Thereby, the determination as to whether the storage medium is a storage medium that correctly returns the response signal based on the identification information of the external electronic device or not can be made by the electronic device.

In the storage medium according to the present invention, the identification information is added to the program. Thereby, the processing by the program to which the identification information is added is executed by the external electronic device.

In the storage medium according to the present invention, the storage medium is an SDIO compliant memory card in which a plurality of pins including the first pin have an SD interface and the second pin is provided. This enables the storage medium to be structured in compliance with the SDIO standard.

According to the present invention, the storage medium storing a program and outputting the program from the first pin, the response unit outputs the response signal in response to the connection check signal outputted from the electronic device, and through the second pin, the connection check signal is inputted and the response signal is outputted. In the electronic device, the input-output unit outputs the connection check signal to the second pin and obtains the response signal, the determination unit determines whether the storage medium is connected or not based on the obtained response signal, and when the determination unit determines that the storage medium is connected, the processing unit executes the processing by the program. This enables the electronic device to determine whether a certified storage medium having a second pin is connected or not based on the response signal, from the storage medium, in response to the connection check signal and execute the processing by the program.

The above and further objects and features of the invention will more fully be apparent from the following detailed description with accompanying drawings.

### BRIEF DESCRIPTION OF THE SEVERAL VIEWS OF THE DRAWINGS

FIG. 1 is a conceptual view showing the appearance of an electronic device system of the present invention;

FIG. 2 is a block diagram showing the functional structure of the inside of an electronic device and an SDIO device included in the electronic device system according to a first embodiment;

FIG. 3 is a schematic view for explaining the structure of connector units of the electronic device and the SDIO device;

FIG. 4 is a perspective view showing the appearance of the SDIO device of FIG. 1;

FIG. 5 is a table showing the pin assignment of SD pin units of the electronic device and the SDIO device;

FIG. 6 is a block diagram showing the signal connection of extended pin units of the electronic device and the SDIO device;

FIG. 7 is a table showing the pin assignment of the extended pin units of the electronic device and the SDIO device;

FIG. 8 is a table showing the correspondence relationship between the model of the electronic device and the connection check signal; and

FIG. 9 is a flowchart showing the processing procedure for reading the control program from the SDIO device to the electronic device and executing it.

### DETAILED DESCRIPTION

### First Embodiment

Hereinafter, the present invention will be concretely described based on the drawings showing embodiments thereof.

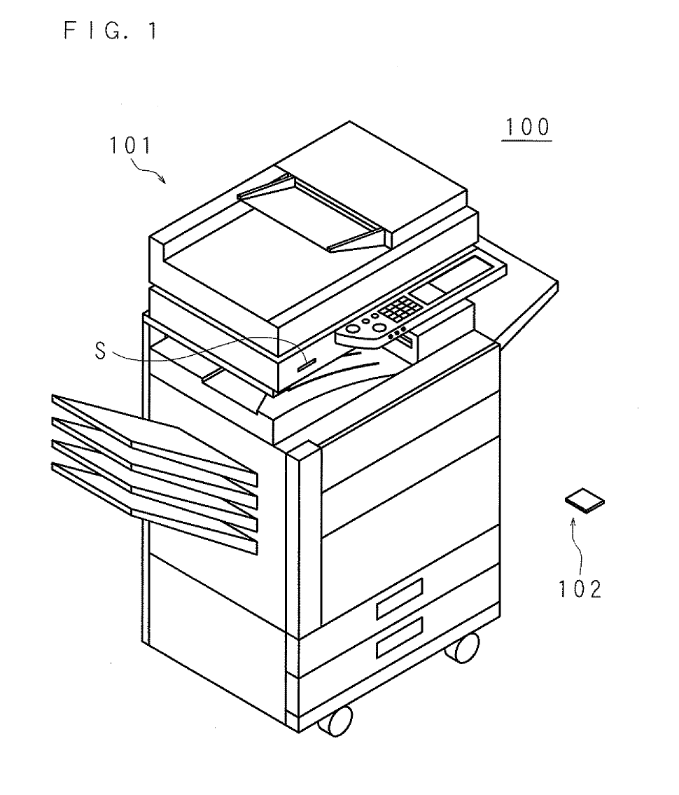

FIG. 1 is a conceptual view showing the appearance of an electronic device system 100 of the present invention. The electronic device system 100 of the present invention is provided with an electronic device 101 and an SDIO (secure digital input output) device 102 detachably attachable to the electronic device 101. In the present embodiment, an example in which the electronic device system 100 is an image forming apparatus is shown. The SDIO device 102 is, for example, an SDIO compliant memory card having a nine-pin SD interface. The SDIO device (storage medium) 102 is connected to the electronic device 101, and stores a control program read by the electronic device 101. While the electronic device system 100 shown in FIG. 1 is structured so that the SDIO device 102 is attached by being inserted into an insertion and extraction slot S provided on the housing of the electronic device 101, it may be structured so that the SDIO device 102 is detachably attached to an electronic circuit board (not shown) provided in the housing of the electronic device 101.

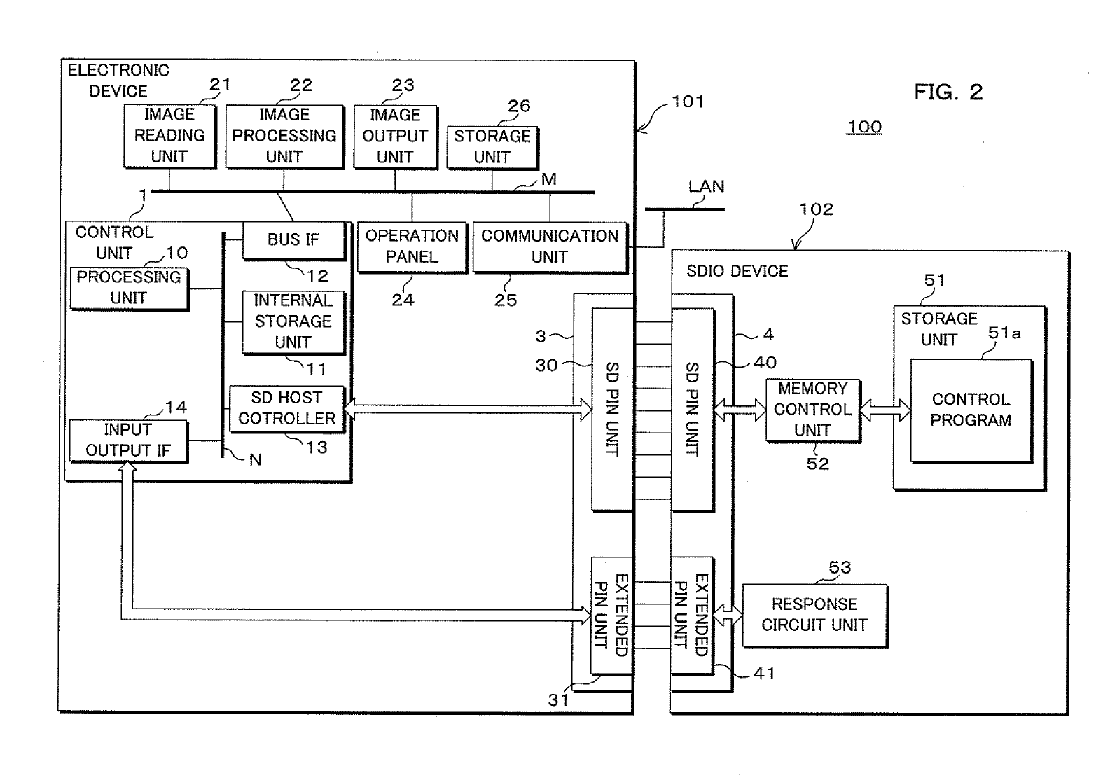

FIG. 2 is a block diagram showing the functional structure of the inside of the electronic device 101 and the SDIO device 102 included in the electronic device system 100 according to a first embodiment. The electronic device 101 is provided with an image reading unit 21, an image processing unit 22, an image output unit 23, an operation panel 24, a communication unit 25 and a storage unit 26, and these pieces of hardware are connected to a control unit 1 by a bus M. The control unit 1 controls these pieces of hardware by executing the processing by the control program read from the SDIO device 102, thereby activating the electronic device 101. These as a whole constitute an image forming apparatus. The electronic device 101 is also provided with a connector unit 3, and the connector unit 3 is connected to the control unit 1.

The image reading unit 21 is provided with an optical unit having an image sensor such as a CCD (charge coupled device) or the like, and optically reads the image data of an original document. The image reading unit 21 forms a reflected light image from the original document on the image sensor, and outputs an RGB (R: red, G: green, B: blue) signal. The RGB signal outputted by the image reading unit 21 is inputted to the image processing unit 22.

The image processing unit 22 generates image data based on the RGB signal outputted from the image reading unit 21 or reads the image data stored in the storage unit 26, processes the image data according to the kind of the image, and then, generates output image data. The output image data generated by the image processing unit 22 is outputted to the image output unit 23 or the communication unit 25.

The image output unit 23 forms an image on a sheet such as a recording paper or an OHP film based on the output image data outputted from the image processing unit 22. The image output unit 23 is provided with: a photoconductor drum; a charger that charges the photoconductor drum to a predetermined potential; an exposing device that generates an electrostatic latent image on the photoconductor drum by emitting laser light or the like according to the externally accepted image data; a developer unit that develops the electrostatic latent image formed on the photoconductor drum surface by supplying toner thereto; and a transferer that transfers the toner image formed on the photoconductor drum surface onto the sheet (these are not shown). The image output unit 23 forms an image desired by the user on a sheet by an electrophotographic method. Instead of performing image formation by an electrophotographic method, the image output unit 23 may perform image formation by an ink-jet method, a thermal transfer method, a sublimation method or the like.

The operation panel 24 is provided with: function buttons such as “facsimile”, “copy”, “print” and “mail” related to various functions of the image forming apparatus; a numeric keypad; an enter key for entering the accepted instruction; and a liquid crystal display, and obtains an operation signal from the user.

The communication unit 25 is provided with a network card, a modem or the like for establishing connection with a network such as a LAN to transmit output image data to the outside. The storage unit 26 is a storage device such as a non-volatile semiconductor memory or a hard disk, and stores image data for image processing and the like.

The control unit (determination unit, second determination unit) 1 is provided with a processing unit 10, an internal storage unit (identification information storage unit) 11, a bus interface 12 (hereinafter, referred to as bus IF 12), an SD host controller 13 and an input-output interface (input-output unit) 14 (hereinafter, referred to as input-output IF 14). These pieces of hardware are connected by an internal bus N of the control unit 1. The processing unit 10 is a CPU that executes the processing by a program. The internal storage unit 11 is provided with a ROM (read only memory) storing the boot program and the identification information of the electronic device and a RAM storing data generated in the program processing. The boot program is the program that is executed first by the processing unit 10 when the electronic device 101 is turned on. Moreover, the identification information of the electronic device 101 is model information to identify the model, or the like. For example, for image forming apparatuses, the model information is predetermined as the identification information to identify the models ranging from low-end models to high-end models according to their different performance such as printing speed.

The bus IF 12 controls the input and output of the internal bus N of the control unit 1 and the bus M to which the image reading unit 21 and the like are connected. The SD host controller 13 outputs a command to the SDIO device 102 to control data reading and writing with the SDIO device 102. While the SD host controller 13 is provided in the control unit 1 in FIG. 2, a part having an SD host controller may be mounted by an SOC (system on a chip), a south bridge chip set or the like. The input-output IF 14 has a plurality of input ports and output ports, and controls input signals and output signals at the ports. The input ports and the output ports of the input-output IF 14 are connected to an extended pin unit 31 described later.

The control unit 1 outputs a connection check signal from the output ports of the input-output IF 14 in order to check if a certified device is connected as the SDIO device 102. The outputted connection check signal is outputted to the SDIO device 102 from the extended pin unit 31 connected to the output ports of the input-output IF 14. The input-output IF 14 obtains a response signal, from the SDIO device 102, in response to the connection check signal, through the input ports connected to the extended pin unit 31. The control unit 1 determines whether the SDIO device 102 is connected or not based on the obtained response signal.

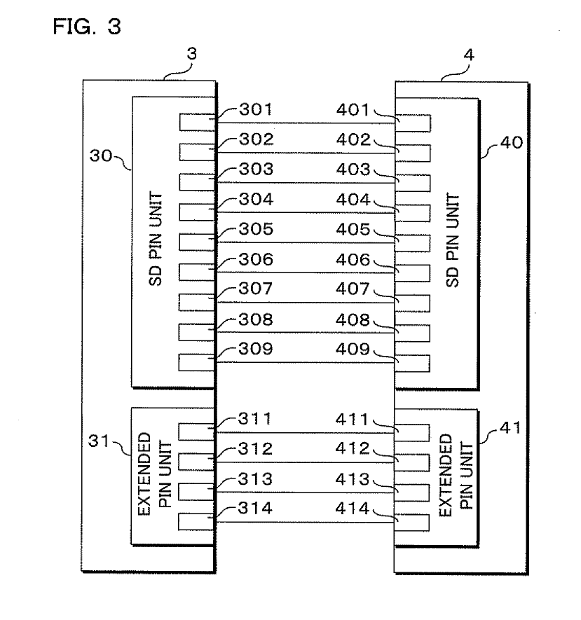

The connector unit 3 is provided with an SD pin unit 30 and the extended pin unit 31. FIG. 3 is a schematic view for explaining the structure of the connector units of the electronic device 101 and the SDIO device 102. The SD pin unit 30 has an SD interface constituted by nine pins (program pin) 301 to 309, and is connected to an SD pin unit 40 of a connector unit 4 in the SDIO device 102 described later. The extended pin unit 31 has four pins (connection check pin) 311 to 314, and is connected to an extended pin unit 41 of the connector unit 4 in the SDIO device 102 described later. The SD pin unit 30 is connected to the SD host controller 13, and the extended pin unit 31 is connected to the input-output IF 14.

The SDIO device 102 is provided with a storage unit 51, a memory control unit 52, a response circuit unit (response unit) 53 and the connector unit 4. The storage unit 51 stores a control program 51a read and executed by the electronic device 101. The storage unit 51 is constituted by a rewritable non-volatile semiconductor memory such as flash memory.

The memory control unit 52 performs data reading from the program storage unit 51 and data writing to the program storage unit 51 based on the command from the SD host controller 13. The memory control unit 52 is connected to the SD pin unit 40, obtains the command from the SD host controller 13 through the SD pin unit 40, and outputs the control program 51a stored in the storage unit 51 to the SD host controller 13.

The response circuit unit 53 is connected to the extended pin unit 41, and outputs a response signal in response to the connection check signal inputted from the electronic device 101, to the extended pin unit 41. The response signal is outputted to the extended pin unit 31 on the side of the electronic device 101 through the extended pin unit 41, and inputted to the input-output IF 14 in the electronic device 101.

The connector unit 4 is provided with the SD pin unit 40 and the extended pin unit 41. The SD pin unit 40 has an SD interface constituted by nine pins (first pin) 401 to 409, and is connected to the SD pin unit 30 of the connector unit 3 in the electronic device 101 (see FIG. 3). The extended pin unit 41 has four pins (second pin) 411 to 414, and is connected to the extended pin unit 31 of the connector unit 3 in the electronic device 101.

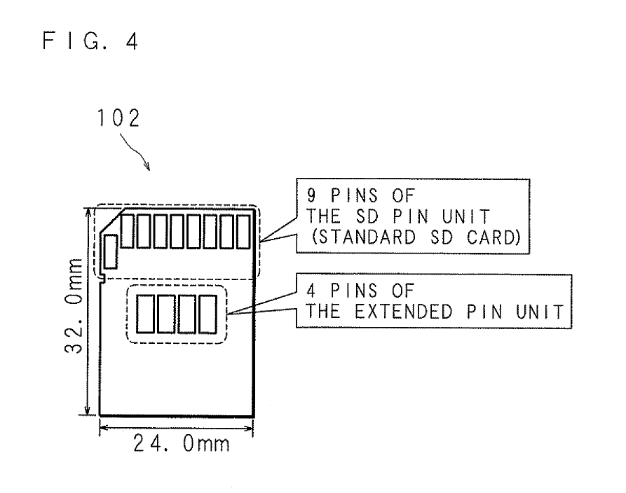

FIG. 4 is a perspective view showing the appearance of the SDIO device 102. As shown in FIG. 4, when the SDIO device 102 is a rectangular memory card substantially the same as an SD memory card, the nine pins of the SD pin unit 40 are arranged on one marginal part of the rectangular memory card like the known SD memory card. The four pins of the extended pin unit 41 are provided, for example, in a substantially central part of the card surface other than the area occupied by the SD pin unit 40. At this time, the pins of the extended pin unit 41 are formed of the same material as the pins of the SD pin unit 40 in substantially the same shape and size. The four pins of the extended pin unit 41 may be arranged in one row and four columns or may be arranged in two rows and two columns. The connector unit 3 on the side of the electronic device 101 is a known SD memory card socket to which the extended pin unit 31 for connection with the extended pin unit 41 is added. For example, the connector unit 3 may be one in which the four pins of the extended pin unit 31 are provided so as to be pressed against the four pins of the extended pin unit 41 in positions opposite to the four pins of the extended pin unit 41 provided in the substantially central part of the card surface.

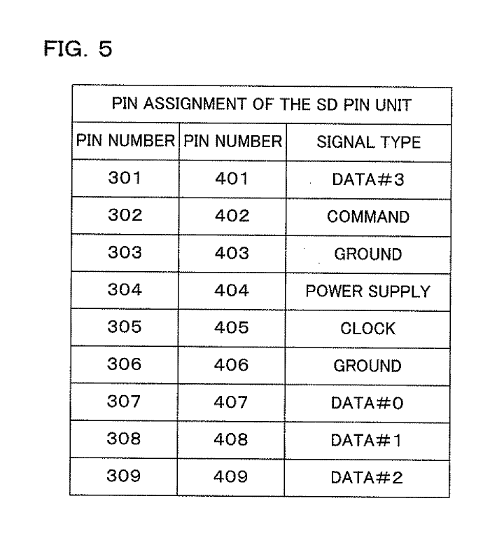

FIG. 5 is a table showing the pin assignment of the SD pin units of the electronic device 101 and the SDIO device 102. Hereinafter, the pin assignment will be explained by using the pin numbers on the side of the SD pin unit 30, and the corresponding pin numbers on the side of the SD pin unit 40 are shown in the parentheses. The pins 307 to 309 (pins 407 to 409) are assigned to data #0 to data #2, respectively, and the pin 301 (pin 401) is assigned to data #3. The SDIO device 102 outputs the control program 51a stored in the storage unit 51 through the pins 401 and 407 to 409. The electronic device 101 reads the control program 51a with the SD host controller 13 through the pins 401 and 407 to 409.

The pin 302 (pin 402) is assigned to a command such as a command to perform reading and writing from the SD host controller 13 to the SDIO device 102. The pins 303 and 306 (pins 403 and 406) are assigned to grounding, the pin 304 (pin 404) is assigned to power supply, and the pin 305 (pin 405) is assigned to clock.

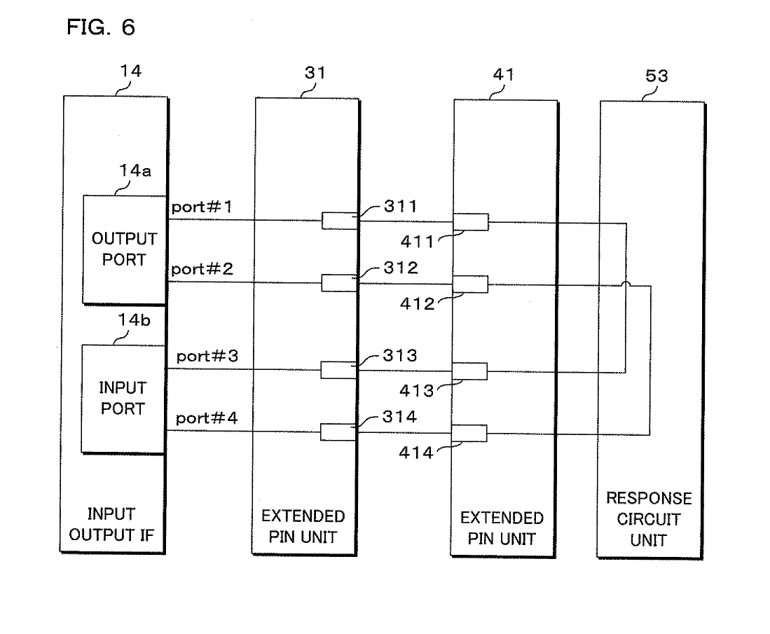

FIG. 6 is a block diagram showing the signal connection of the extended pin units of the electronic device 101 and the SDIO device 102. The input-output IF 14 is provided with an output port 14a to output the connection check signal to the SDIO device 102 and an input port 14b to obtain the response signal from the SDIO device 102. At the output port 14a, the port #1 is connected to the pin 311 of the extended pin unit 31, and the port #2 to the pin 312. At the input port 14b, the port #3 is connected to the pin 313 of the extended pin unit 31, and the port #4 to the pin 314. The response circuit unit 53 on the side of the SDIO device 102 connects the signal line connected to the pin 411 of the extended pin unit 41 to the pin 413, and connects the signal line connected to the pin 412 to the pin 414. The response circuit unit 53 shown in FIG. 6 is a simple circuit that returns the connection check signal as it is.

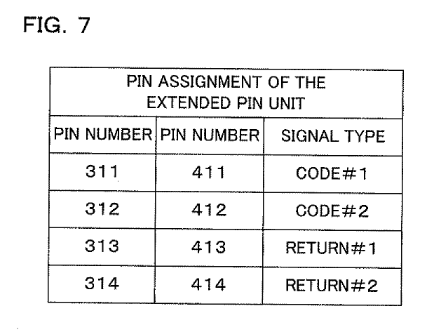

FIG. 7 is a table showing the pin assignment of the extended pin units of the electronic device 101 and the SDIO device 102. Hereinafter, the pin assignment will be explained by using the pin numbers on the side of the extended pin unit 31, and the corresponding pin numbers on the side of the extended pin unit 41 are shown in the parentheses. The pins 311 and 312 (pins 411 and 412) are assigned to the codes of the connection check signal. The pins 313 and 314 (pins 413 and 414) are assigned to the returns of the response signal.

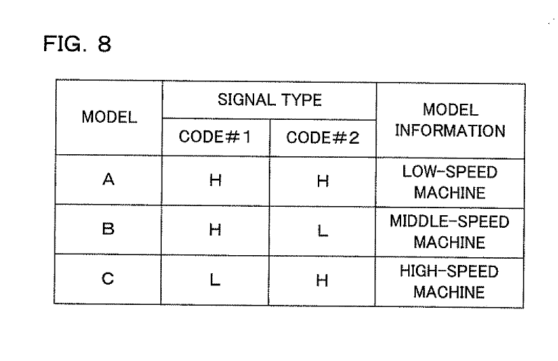

FIG. 8 is a table showing the correspondence relationship between the model of the electronic device 101 and the connection check signal. The connection check signal is identification information to identify three kinds of models according to whether the code #1 and the code #2 are high or low. The models are ranked according to the processing speed as an example. The model A is a low-speed machine, the model B is a middle-speed machine, and the model C is a high-speed machine. In the image forming apparatuses, the processing speed corresponds to printing speed, image read speed or the like. For the connection check signal of the model A, the code #1 is high and the code #2 is high (the codes for the model B and the model C are as shown in FIG. 8). As such a connection check signal, the identification information (in this example, 2-bit information) to identify the model is stored in the ROM of the internal storage unit 11, and the identification information is read by the processing unit 10 and outputted. The control unit 1 can determine whether the certified SDIO device 102 that correctly returns the identification information is connected or not based on whether the outputted connection check signal and the response signal coincide with each other or not.

For simply checking that signals are inputted and outputted by the extended pin unit 31 and the extended pin unit 41 between the electronic device 101 and the SDIO device 102, the connection check signal may be any given signal regardless of the type of the signal. In this case, the control unit 1 can determine whether the certified SDIO device 102 having the extended pin unit 41 is connected or not based on whether the outputted connection check signal and the response signal coincide with each other or not. For example, when an SD memory card having no extended pin unit 41 is connected, since the outputted connection check signal and the response signal do not coincide with each other, a determination can be made that the connected device is a non-certified one.

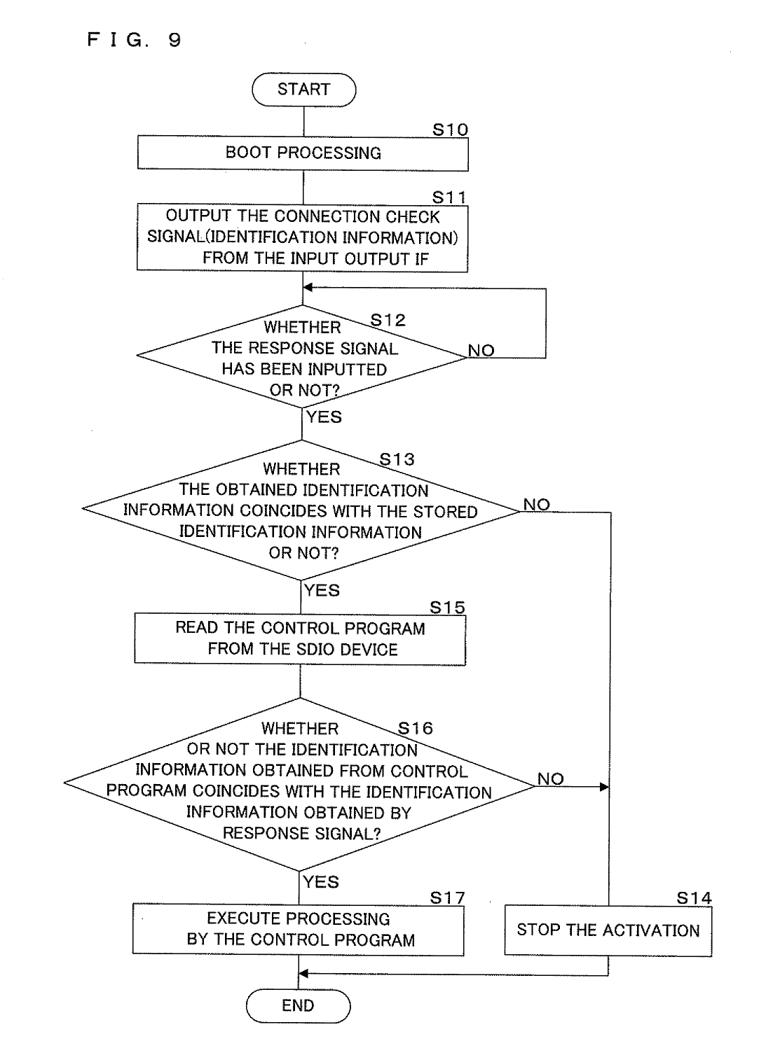

Next, the processing performed when the control program is read from the SDIO device 102 to the electronic device 101 and executed will be described. FIG. 9 is a flowchart showing the processing procedure for reading the control program from the SDIO device 102 to the electronic device 101 and executing it. In the processing procedure shown in FIG. 9, a case will be described in which the identification information to identify the model as shown in FIG. 8 is used as the connection check signal. When the electronic device 101 is turned on, the control unit 1 performs the boot processing (step S10). In the boot processing, the processing unit 10 executes the boot program stored in the ROM of the internal storage unit 11, performs the initialization and operation check of the pieces of hardware in the control unit 1 and connected to the bus M, and establishes the input and output relationship among the pieces of hardware.

In the boot processing at step S10, whether the connector unit 4 of the SDIO device 102 is attached to the connector unit 3 of the electronic device 101 or not is automatically recognized. This is automatic recognition of the SDIO device 102 on the side of the SD host controller 13 according to the SD interface. However, this automatic recognition is recognition of the connection of an SD memory card through the SD pin unit 30 and the SD pin unit 40, and in this stage, is not recognition through the extended pin unit 31 and the extended pin unit 41.

The control unit 1 reads the identification information stored in the ROM of the internal storage unit 11, and outputs it as the connection check signal from the input-output IF 14 (step S11). The connection check signal is inputted to the SDIO device 102 through the extended pin unit 31 and the extended pin unit 41. By the signal connection shown in FIG. 6, the response circuit unit 53 returns the inputted identification information as the response signal and outputs it. The control unit 1 determines whether the response signal has been inputted to the input-output IF 14 through the extended pin unit 31 and the extended pin unit 41 or not (step S12). When the response signal has not been inputted (S12: NO), the control unit 1 determines that the SDIO device 102 is not connected, and repeats step S12. For example, when an SD memory card having no extended pin unit 41 is connected to the connector unit 3, step S12 is repeated, so that the activation of the electronic device 101 is retarded and the activation is stopped by separate timeout processing or the like.

When determining that the response signal has been inputted at step S12 (S12: YES), the control unit 1 determines that the SDIO device 102 is connected, and then, determines whether or not the identification information obtained by the response signal coincides with the identification information stored in the ROM of the internal storage unit 11 (step S13). When determining that the identification information does not coincide at step S13 (S13: NO), the control unit 1 stops the activation of the electronic device 101 (step S14), and ends the processing. The activation of the electronic device 101 can be stopped when, for example, an imitation SDIO device 102 whose response circuit unit 53 cannot correctly return the identification information is connected.

When determining that the identification information coincides at step S13 (S13: YES), the control unit 1 determines the SDIO device 102 as a certified one, and the control program 51a is read from the SDIO device 102 through the SD pin unit 30 and the SD pin unit 40 by the SD host controller 13 (step S15). The control unit 1 reads the identification information added to the control program 51a read by the SD host controller 13, and determines whether it coincides with the identification information obtained by the response signal or not (step S16). While the control unit 1 determines the coincidence of the identification information added to the control program 51a with the identification information obtained by the response signal in this description, this is substantially synonymous with the determination of the coincidence with the identification information stored in the ROM of the internal storage unit 11.

When determining that the identification information does not coincide (S16: NO), the control unit 1 determines that the control program 51a is a control program 51a for a model different from the model of the electronic device 101 identified by the identification information stored in the ROM of the internal storage unit 11, stops the activation of the electronic device 101 (step S14), and ends the processing. The activation of the electronic device 101 can be stopped when, for example, the control program 51a has been rewritten to a control program 51a for a different model although the SDIO device 102 is a certified one and the correct response signal is outputted from the extended pin unit 41.

When determining that the identification information coincides (S16: YES), the control unit 1 executes the control program 51a read by the SD host controller 13 (step S17), and ends the processing to be performed when the control program 51a is read from the SDIO device 102 to the electronic device 101 and executed.

As described above, according to the present embodiment, the connection check signal is inputted from the electronic device 101 to the SDIO device 102 through the extended pin unit 31 and the extended pin unit 41, and whether the response signal has been inputted to the input-output IF 14 or not is determined. By the determination, when the response signal has not been inputted, the control unit 1 determines that the SDIO device 102 is not connected, and can stop the activation of the electronic device 101. In this determination, the connection check signal is not necessarily an identification signal to identify the model, but may be any given signal.

Moreover, the identification information is inputted from the electronic device 101 to the SDIO device 102 as the connection check signal through the extended pin unit 31 and the extended pin unit 41, and the response circuit unit 53 of the SDIO device 102 outputs the inputted identification information as the response signal. The control unit 1 determines whether or not the identification information obtained from the response signal coincides with the identification information stored in the ROM of the internal storage unit 11. By the determination, when determining that the identification information does not coincide, the control unit 1 stops the activation of the electronic device 101, and ends the processing. The activation of the electronic device 101 can be stopped when, for example, an imitation SDIO device 102 whose response circuit unit 53 cannot correctly return the identification information is connected.

Moreover, the control unit 1 reads the identification information added to the control program 51a read by the SD host controller 13, and determines whether it coincides with the identification information obtained from the response signal or not. By the determination, when the control program 51a has been rewritten to a control program 51a for a different model although the SDIO device 102 is a certified one and the correct response signal is outputted from the extended pin unit 41, the control unit 1 can stop the activation of the electronic device 101.

Moreover, according to the present embodiment, since the control program stored in the SDIO device 102 is read by the SD host controller 13 when the identification information coincides (S13:YES, as shown in FIG. 9), a control program stored in a non-certified SDIO device can be prevented from being read.

### (Modification)

While in the above-described embodiment, as shown in FIG. 6, the response circuit unit 53 of the SDIO device 102 connects the pin 411 and the pin 412 to the pin 413 and the pin 414, respectively, and returns the inputted signal as it is, the response circuit unit 53 may perform a specific signal conversion on the connection check signal (identification information) to generate the response signal and output it. In this case, based on the obtained response signal, the control unit 1 performs, on the response signal, a conversion inverse to the specific signal conversion performed by the response circuit unit 53, thereby obtaining the identification information. With the signal conversion of the connection check signal by the response circuit unit 53 and the inverse conversion of the response signal by the control unit 1, the determinations in the above-described embodiment (steps S12, S13 and S16 in FIG. 9) can be similarly performed, and the activation and stopping of the electronic device 101 can be controlled.

Moreover, while in the above-described embodiment, as shown in FIG. 7, the connection check signal (and the identification information) is constituted by two bits of the code #1 and the code #2 and parallelly outputted by the pin 311 and the pin 312 and the same applies to the response signal, the number of bits may be increased by increasing the number of pins. Moreover, the connection check signal may be constituted by two or more bits and outputted serially. In this case, the pin 311 (411) is assigned to the output synchronization of the connection check signal, the pin 312 (412), to the connection check signal output (serial signal), the pin 313 (413), to the output synchronization of the response signal, the pin 314 (414), to the response signal output (serial signal), and the input-output IF 14 and the response circuit unit 53 are provided with a serial signal interface. Since the numbers of bits of the connection check signal and the response signal are increased, a lot of identification information can be obtained, so that models can be minutely identified.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An electronic device system comprising:
a storage medium storing a program and outputting the program from a first pin; and
an electronic device to which the storage medium is detachably connected so as to read the program from the storage medium and execute processing by the program, wherein
the storage medium is provided with:
a response unit that outputs a response signal in response to a connection check signal outputted from the electronic device; and
a second pin to which the connection check signal is inputted and outputting the response signal outputted by the response unit, and
the electronic device is provided with:
an input-output unit that outputs the connection check signal to the second pin and obtains the response signal from the second pin;
a determination unit that determines whether the storage medium is connected or not based on the response signal obtained by the input-output unit; and
a processing unit that executes processing by the program when the determination unit determines that the storage medium is connected.

2. The electronic device system according to claim 1, wherein
the electronic device is provided with an identification information storage unit storing identification information of the electronic device itself,
the input-output unit outputs the identification information stored in the identification information storage unit,
the response unit outputs the response signal based on the inputted identification information, and
when the identification information stored in the identification information storage unit coincides with identification information obtained based on the response signal, the determination unit determines that the storage medium is connected.

3. The electronic device system according to claim 2, wherein
the identification information is added to the program stored in the storage medium,
the electronic device is provided with a second determination unit that determines whether or not the identification information obtained based on the response signal coincides with the identification information obtained from the program, and
when the determination unit determines that the storage unit is connected and the second determination unit determines that the identification information coincides, the processing unit executes processing by the program.

4. The electronic device system according to claim 1, wherein
the storage medium is an SDIO (secure digital input output) compliant memory card in which a plurality of pins including the first pin have an SD (secure digital) interface and the second pin is provided.

5. The electronic device system according to claim 2, wherein
the storage medium is an SDIO (secure digital input output) compliant memory card in which a plurality of pins including the first pin have an SD (secure digital) interface and the second pin is provided.

6. The electronic device system according to claim 3, wherein
the storage medium is an SDIO (secure digital input output) compliant memory card in which a plurality of pins including the first pin have an SD (secure digital) interface and the second pin is provided.

7. An electronic device that reads a program from an external storage medium and executes processing by the program, the electronic device comprising:
a program pin to which the program is inputted;
a connection check pin that outputs, to an external device, a connection check signal to check connection and to which a response signal in response to the connection check signal is inputted;
an input-output unit connected to the connection check pin and outputting the connection check signal and obtaining the response signal;
a determination unit that determines whether the storage medium is connected or not based on the response signal; and
a processing unit that executes, when the determination unit determines that the storage medium is connected, processing by the program inputted to the program pin.

8. The electronic device according to claim 7, wherein
the electronic device is provided with an identification information storage unit storing identification information of the electronic device itself,
the input-output unit outputs the identification information stored in the identification information storage unit, and
when the identification information stored in the identification information storage unit coincides with identification information obtained based on the response signal, the determination unit determines that the storage medium is connected.

9. The electronic device according to claim 8, wherein
the identification information is added to the program,
the electronic device is provided with a second determination unit that determines whether or not the identification information obtained based on the response signal coincides with the identification information obtained from the program, and
when the determination unit determines that the storage unit is connected and the second determination unit determines that the identification information coincides, the processing unit executes processing by the program.

10. A storage medium connected to an external electronic device and storing a program and outputting the program from a first pin, the storage medium comprising:
a response unit that outputs a response signal in response to an externally inputted connection check signal; and
a second pin to which the connection check signal is inputted and outputting the response signal outputted by the response unit.

11. The storage medium according to claim 10, wherein
the response unit outputs the response signal, based on identification information of the electronic device included in the connection check signal.

12. The storage medium according to claim 11, wherein
the identification information is added to the program.

13. The storage medium according to claim 10, wherein
the storage medium is an SDIO compliant memory card in which a plurality of pins including the first pin have an SD interface and the second pin is provided.

14. The storage medium according to claim 11, wherein
the storage medium is an SDIO compliant memory card in which a plurality of pins including the first pin have an SD interface and the second pin is provided.

15. The storage medium according to claim 12, wherein
the storage medium is an SDIO compliant memory card in which a plurality of pins including the first pin have an SD interface and the second pin is provided.
